(19) United States
(12) Patent Application Publication
(10) Pub. No.: US 2025/0326310 A1
(43) Pub. Date: Oct. 23, 2025

(54) INTELLIGENT LAWN MOWER AND AUTOMATIC WORKING SYSTEM

(71) Applicant: JIANGSU DONGCHENG M & E TOOLS CO., LTD., Nantong (CN)

(72) Inventors: Chen CHEN, Nantong (CN); Hongyue LONG, Nantong (CN)

(73) Assignee: JIANGSU DONGCHENG M & E TOOLS CO., LTD., Nantong (CN)

(21) Appl. No.: 19/254,002

(22) Filed: Jun. 30, 2025

Related U.S. Application Data
(63) Continuation-in-part of application No. PCT/CN2024/115415, filed on Aug. 29, 2024.

(30) Foreign Application Priority Data
Sep. 26, 2023 (CN) 202311262871.6

(51) Int. Cl. B60L 53/37; A01D 34/00; A01D 101/00; B60L 53/16; B60L 53/30; B60L 53/36

(52) U.S. Cl. CPC B60L 53/37; A01D 34/008; B60L 53/16; B60L 53/30; B60L 53/36; A01D 2101/00; B60L 2200/40

(57) ABSTRACT

An intelligent lawn mower is provided. The intelligent lawn mower includes a housing, an energy module for supplying power to the intelligent lawn mower and installed in the housing, and charging terminals installed in the housing and electrically connected to the energy module. The charging station is connected to the charging terminals to recharge the energy module. The intelligent lawn mower further includes an infrared sensing device for guiding the intelligent lawn mower back to the charging station. The housing includes a terminal seat provided with the charging terminals, and the infrared sensing device is installed on the terminal seat. By fixedly installing the infrared sensing device used for achieving recharging guidance on the terminal seat, the need for an additional component to support and fix the infrared sensing device is eliminated, thereby reducing manufacturing costs and making the structure of the intelligent lawn mower more compact.

### CROSS-REFERENCE TO RELATED APPLICATIONS

This application is a continuation-in-part of International Patent Application No. PCT/CN2024/115415, filed on Aug. 29, 2024, which claims priority to Chinese Patent Application No. 202311262871.6, filed on Sep. 26, 2023. All of the aforementioned patent applications are hereby incorporated by reference in their entireties.

### TECHNICAL FIELD

This invention relates to the field of garden tools, and in particular to an intelligent lawn mower and an automatic working system.

### BACKGROUND

An intelligent lawn mower typically includes a housing, a moving device, a cutting device, and a battery pack, wherein the battery pack can provide the necessary electrical energy for the moving device and the cutting device. During use, a designated cutting area for the lawn mower's movement is preset on the lawn, and a charging station is set up within this area. When detecting a low battery level in the battery pack, the intelligent lawn mower can automatically return to the charging station and dock with charging terminals inside the charging station to charge the battery pack. After detecting that the battery level of the battery pack meets the working requirements, the intelligent lawn mower will automatically leave the charging station and continue to trim the lawn within the designated cutting area.

In the market, there are many ways to guide the intelligent lawn mower to return for being charged. One common method is to install an infrared sensing device on the lawn mower, which cooperates with the charging station to achieve charging guidance. Regarding how the infrared sensing device is installed on the intelligent lawn mower, the mainstream installation method is as follows: the intelligent lawn mower is provided with a fixing seat to carry the infrared sensing device, and the fixing seat is installed on the outer surface of the housing to achieve a fixed connection between the infrared sensing device and the intelligent lawn mower.

However, the above-mentioned installation method for the infrared sensing device has the following issues: on one hand, an additional fixing seat needs to be designed to install the infrared sensing device, which increases costs; on the other hand, the fixing seat is installed on the outer surface of the intelligent lawn mower, making the infrared sensing device susceptible to external environmental light, such as sunlight, which can cause false triggering.

In view of the above, it is necessary to provide an improved intelligent lawn mower to overcome the defects in the prior art.

### SUMMARY

In view of the shortcomings of the prior art, the object of the present invention is to provide an intelligent lawn mower and an automatic working system with high accuracy of returning back to be recharged and lower installation costs for the infrared sensing device.

According to a first aspect, the present invention provides an intelligent lawn mower which includes a housing, wherein an energy module, a plurality of charging terminals, an infrared sensing device, and a terminal seat are provided in the housing. The energy module is configured for supplying power to the intelligent lawn mower. The charging terminals are electrically connected to the energy module and configured to connect to an external charging station for recharging the energy module. The infrared sensing device is configured to guide the intelligent lawn mower back to the charging station. The terminal seat is provided with the charging terminals, and the infrared sensing device is installed on the terminal seat.

In one embodiment of the intelligent lawn mower, the housing includes a first shell and a second shell, the first shell and the second shell are connected to each other to define a first cavity, the terminal seat and the first shell are connected to each other to define a second cavity, the first cavity and the second cavity are communicated with each other.

In one embodiment of the intelligent lawn mower, the first shell includes a first opening communicating with the first cavity, the terminal seat includes a second opening communicating with the second cavity, the second opening and the first opening are communicated with each other.

In one embodiment of the intelligent lawn mower, the intelligent lawn mower further includes first wires and a control module electrically connected to the infrared sensing device through the first wires, the control module is at least partially accommodated in the first cavity, the first wires extend from the second cavity and pass through the first opening and the second opening into the first cavity.

In one embodiment of the intelligent lawn mower, the intelligent lawn mower further includes second wires extending from the second cavity and passing through the first opening and the second opening into the first cavity, and the charging terminals are electrically connected to the control module through the second wires.

In one embodiment of the intelligent lawn mower, the first opening is opened downward along a height direction of the intelligent lawn mower.

In one embodiment of the intelligent lawn mower, the second opening is opened upward along a height direction of the intelligent lawn mower.

In one embodiment of the intelligent lawn mower, the terminal seat further includes a third opening communicating with the second cavity, and the third opening is located in front of the infrared sensing device for allowing the infrared sensing device to receive external light through the third opening.

In one embodiment of the intelligent lawn mower, the terminal seat further includes a light-transmitting plate allowing external light to pass through, and the light-transmitting plate covers the third opening.

In one embodiment of the intelligent lawn mower, a direction in which the intelligent lawn mower enters the charging station is defined as a front direction, the housing further includes a light-blocking cover at least partially positioned in front of the terminal seat, and the light-blocking cover is partially positioned above the terminal seat to block ambient light.

In one embodiment of the intelligent lawn mower, the light-blocking cover and at least one of the first shell and the second shell are connected to each other to define a third cavity, and the terminal seat is accommodated in the third cavity.

In one embodiment of the intelligent lawn mower, the light-blocking cover includes a light-transmitting opening, the infrared sensing device receives external light through the light-transmitting opening, and a horizontal distance between an installation position of the infrared sensing device and the light-transmitting opening is not less than 30 mm.

In one embodiment of the intelligent lawn mower, the infrared sensing device includes a circuit board and a photodiode installed on the circuit board, with the photodiode facing the light-transmitting opening, and the photodiode receives external light through the light-transmitting opening.

In one embodiment of the intelligent lawn mower, the light-transmitting opening includes a first opening wall and a second opening wall located below the first opening wall, in a height direction of the intelligent lawn mower, an installation position of the photodiode is located between the first opening wall and the second opening wall.

In one embodiment of the intelligent lawn mower, the light-transmitting opening further includes a light entry point formed at a lowermost part of the first opening wall and located at a frontmost part of the first opening wall, an angle between a connecting line between the light entry point and a center point of the photodiode and a horizontal line is not greater than 15 degrees.

In one embodiment of the intelligent lawn mower, a first sealing member is installed at the connection between the first shell and the second shell, and a second sealing member is installed at the connection between the first shell and the terminal seat.

In one embodiment of the intelligent lawn mower, the charging terminals includes a first electrode and a second electrode arranged in parallel to the first electrode; and the infrared sensing device is provided between the first electrode and the second electrode.

In one embodiment of the intelligent lawn mower, the infrared sensing device is provided in the second cavity.

According to a second aspect, the present invention provides an automatic working system. The automatic working system includes an intelligent lawn mower and an external charging station for recharging the intelligent lawn mower. The intelligent lawn mower includes a housing, wherein an energy module, a plurality of charging terminals, an infrared sensing device, and a terminal seat are provided in the housing. The energy module is configured for supplying power to the intelligent lawn mower. The charging terminals are electrically connected to the energy module and configured to connect to the external charging station for recharging the energy module. The infrared sensing device is configured to guide the intelligent lawn mower back to the charging station. The terminal seat is provided with the charging terminals, and the infrared sensing device is installed on the terminal seat.

According to a third aspect, the present invention provides an automatic working system. The automatic working system includes an intelligent lawn mower and an external charging station. The intelligent lawn mower can autonomously move and mow within a working area, and includes a housing, a plurality of charging terminals, a terminal seat provided with the charging terminals, and an infrared sensing device provided in the housing. The external charging station is configured to be connected to the charging terminals for recharging the intelligent lawn mower. The charging station includes an infrared emitting device, and the infrared emitting device cooperates with the infrared sensing device to guide the intelligent lawn mower back to the charging station. The infrared sensing device is installed on the terminal seat. The housing is provided with a light-transmitting opening, and the infrared sensing device receives external light through the light-transmitting opening. A horizontal distance between an installation position of the infrared sensing device and the light-transmitting opening is not less than 30 mm.

Compared with the prior art, the intelligent lawn mower and the automatic working system provided by the present invention have the following advantages: by fixedly installing the infrared sensing device used for achieving recharging guidance and the charging terminals on the terminal seat, the need for an additional component to support and fix the infrared sensing device is eliminated, thereby reducing manufacturing costs and making the structure of the intelligent lawn mower more compact. Further, by installing the infrared sensing device inside the housing of the intelligent lawn mower, the sunlight is avoided from illuminating the infrared sensing device to cause the intelligent lawn mower to falsely trigger the recharging process when the intelligent lawn mower performs mowing operations in an outdoor environment.

### BRIEF DESCRIPTION OF THE DRAWINGS

Specific embodiments of the present invention are described in detail below in conjunction with the accompanying drawings:

FIG. 1 is a schematic diagram of the overall structure of the automatic working system in a preferred embodiment of the present invention.

FIG. 2 is a partial cross-sectional view of the automatic working system shown in FIG. 1.

FIG. 3 is a partial enlarged view of part A of the automatic working system shown in FIG. 2.

FIG. 4 is a structural diagram of the terminal seat of the intelligent lawn mower in the automatic working system shown in FIG. 1.

### DETAILED DESCRIPTION OF THE EMBODIMENTS

The following will provide a clear and complete description of the technical solution of the present invention in conjunction with the accompanying drawings. Obviously, the described embodiments are only a part of the embodiments of the present invention, not all of them. Based on the embodiments of the present invention, all other embodiments obtained by those of ordinary skill in the art without creative efforts are within the scope of protection of the present invention. In the description of this specification, the specific features, structures, materials, or characteristics described may be combined in a suitable manner in any one or more embodiments or examples.

Terminology used in the present invention is merely for the purpose of describing the specific embodiments only and is not intended to limit the present invention. For example, the following terms indicating orientation or positional relationships such as “upper,” “lower,” “front,” “rear”, etc. are only based on the orientation or positional relationships shown in the accompanying drawings, for the convenience of describing the present invention and simplifying the description, and do not indicate or imply that the device/element referred to must have a specific orientation or be constructed and operated in a specific orientation, and therefore cannot be understood as limiting the present invention.

Further, the technical features involved in different embodiments of the present invention described below can be combined with each other as long as they do not conflict with each other.

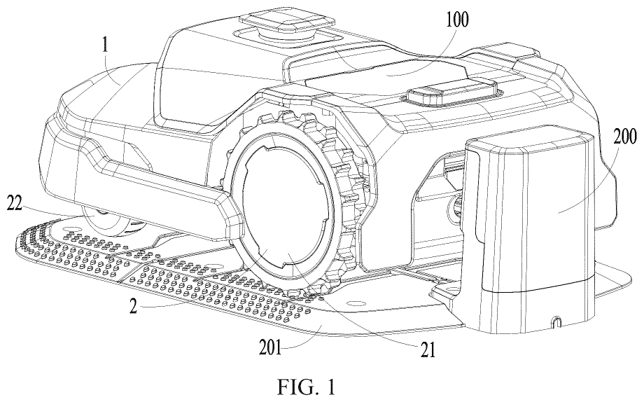

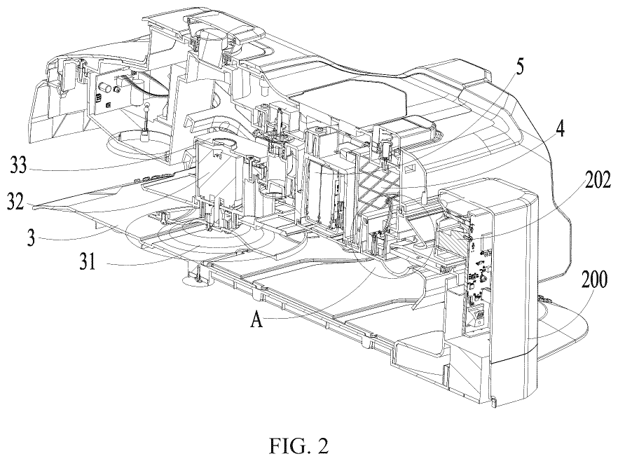

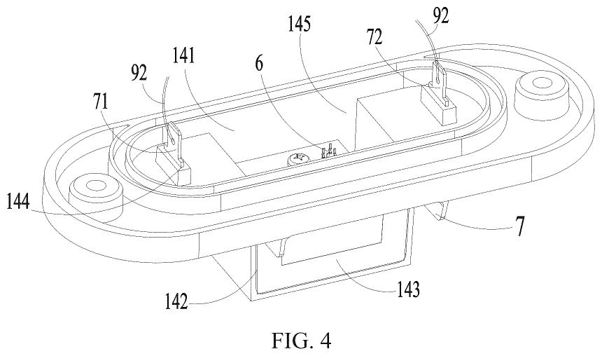

Please refer to FIGS. 1 to 4, an automatic working system according to an embodiment of the present invention is shown, which includes an intelligent lawn mower 100 and a charging station 200 for docking and recharging the intelligent lawn mower 100.

The intelligent lawn mower 100 can autonomously moves and mows within a working area, and includes a housing 1, a driving module 2 for supporting the movement of the housing 1, a cutting module 3 provided at the bottom of the housing 1, a control module 4 provided in the housing 1 for controlling the automatic operation of the driving module 2 and the automatic operation of the cutting module 3, and an energy module 5 for supplying energy to the intelligent lawn mower 100.

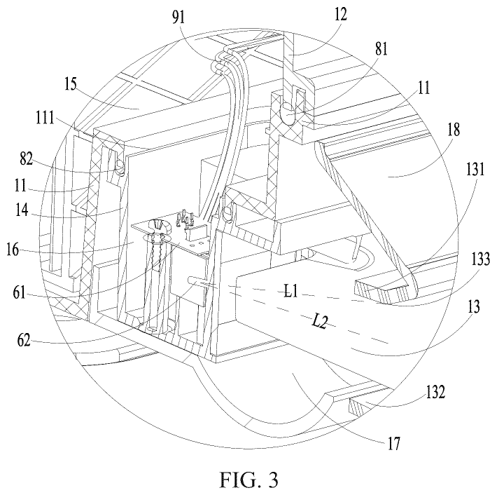

As shown in FIG. 3, the housing 1 includes a first shell 11 and a second shell 12 connected to the first shell 11. The first shell 11 is used to install functional structures and modules such as the driving module 2, the cutting module 3, the control module 4 and the energy module 5, while the second shell 12 is constructed to at least partially cover the first shell 11 to mainly enhance the aesthetic appeal and recognizability of the intelligent lawn mower 100.

It should be noted that the first shell 11 serves as the base for installing various functional structures and modules, and the second shell 12 serves as the cover, which is only one optional embodiment of the present invention. In other embodiments, the second shell 12 can also serve as the base, while the first shell 11 serves as the cover.

The driving module 2 is used to drive the intelligent lawn mower 100 to move within the working area, and includes a driving wheel 21 and an auxiliary wheel 22 that are installed on the housing 1. Specifically, there are two driving wheels 21, each connected to a corresponding driving motor (not shown), and the driving motor drives the driving wheel 21 to rotate so as to achieve the automatic movement of the intelligent lawn mower 100. The auxiliary wheel 22 provides support for the intelligent lawn mower 100. The auxiliary wheel 22 is not connected to the driving motor, but is driven to roll along when supporting the movement of the intelligent lawn mower 100.

With the above structural settings, the intelligent lawn mower 100 can be controlled by the control module 4 to move and turn flexibly on the working surface. During normal movement, the two driving motors output the same speed, directly driving or indirectly driving the intelligent lawn mower 100 through gear or belt transmission structures, with the auxiliary wheel 22 rolling along. During turning, the two driving motors output different speeds, and the intelligent lawn mower 100 will turn towards the side of the driving wheel 21 with lower speed or the side of the driving wheel 21 with reverse direction.

The cutting module 3 at least includes a cutting element 31 for trimming the lawn and a cutting motor 32 for driving the cutting element 31. Specifically, the cutting motor 32 is installed on the first shell 11 of the housing 1, and the cutting motor 32 is electrically connected to the control module 4. The control module 4 can control the cutting motor 32 to start or stop, and can regulate the speed of the cutting motor 32. The cutting motor 32 is accommodated in a motor sleeve 33. A four-bar linkage structure is provided between the motor sleeve 33 and the first shell 11, and the four-bar linkage structure is rotatably connected to the motor sleeve 33 and the first shell 11.

In this embodiment, when the intelligent lawn mower 100 encounters obstacles such as rocks or low shrubs during movement, the cutting element 31 will not collide directly with the obstacles, but will be pushed by the obstacles to drive the motor sleeve 33 to move in the height direction. This design, on one hand, prevents the cutting element 31 from being damaged due to direct collision with the obstacles, and on the other hand, enhances the obstacle-crossing capability of the intelligent lawn mower 100. It should be noted that the cutting element 31 can be a cutting disc with multiple cutting blades installed on the cutting disc, or be cutting blades alone, which is not limited here.

The control module 4 is used to control the automatic movement and operation of the intelligent lawn mower 100, and its functions include controlling the cutting module 3 to start or stop, generating movement paths and controlling the driving module 2 to move according to the paths, receiving environmental signals detected by the intelligent lawn mower 100, judging the power level of the energy module 5 and timely controlling the intelligent lawn mower 100 to return back to the charging station 200 for automatic docking and recharging, etc.

The energy module 5 is used to supply power to the intelligent lawn mower 100, and is installed within the above-mentioned housing 1. Specifically, the energy module 5 is constructed as a battery pack. The first shell 11 is provided with a battery compartment (not shown), and the battery pack is removably installed in the battery compartment. The battery pack is electrically connected to the above-mentioned battery compartment, and leading wires (not shown) extend out from the battery compartment to electrically connect with the driving module 2, the cutting module 3, and the control module 4 mentioned above, thereby enabling the battery pack to supply power to these functional modules mentioned above.

For ease of understanding, in the present invention, taking the horizontal working surface that the intelligent lawn mower 100 travels over during cutting operations as a reference, the plane parallel to this horizontal working surface is defined as the horizontal plane, the direction perpendicular to this horizontal working surface is defined as the height direction of the intelligent lawn mower 100, and the direction in which the intelligent lawn mower 100 enters the charging station 200 is defined as the front direction.

The intelligent lawn mower 100 is provided with a plurality of charging terminals 7 electrically connected to the battery pack. Correspondingly, the charging station 200 is provided with docking terminals (not shown). When the intelligent lawn mower 100 docks with the charging station 200, the docking terminals of the charging station 200 connect with the charging terminals 7 of the above-mentioned intelligent lawn mower 100 to recharge the battery pack.

The charging station 200 is provided with a flat plate 201 for the intelligent lawn mower 100 to dock on, and the flat plate 201 is laid flat on the ground. When the intelligent lawn mower 100 is entirely located on the flat plate 201, the intelligent lawn mower 100 is prevented from tilting due to uneven ground, which may otherwise cause the above-mentioned docking terminals to be unable to dock with the charging terminals 7.

The intelligent lawn mower 100 further includes an infrared sensing device 6 for guiding the intelligent lawn mower 100 back to the charging station 200. Specifically, the infrared sensing device 6 of the intelligent lawn mower 100 is designed as an infrared receiving device for receiving infrared signals. Correspondingly, the charging station 200 is further provided with an infrared emitting device (not shown) for emitting infrared signals. The infrared emitting device cooperates with the above-mentioned infrared receiving device to guide the intelligent lawn mower 100 back to the charging station 200.

During the process of recharging and docking between the intelligent lawn mower 100 and the charging station 200, the control module 4 of the intelligent lawn mower 100 can determine the direction of the intelligent lawn mower 100 based on the received infrared signals, and continuously adjust its orientation according to the location of the charging station 200 until the intelligent lawn mower 100 directly faces the charging station 200. The control module 4 controls the intelligent lawn mower 100 to move in the direction towards the charging station 200 until it docks with the charging station 200.

The housing 1 further includes a terminal seat 14 provided with the charging terminals 7, and the above-mentioned infrared sensing device 6 is installed on the terminal seat 14. Specifically, the terminal seat 14 is installed on the first shell 11, and the charging terminals 7 are fixedly installed on the terminal seat 14 through methods including but not limited to welding or injection molding.

In this embodiment, by fixedly installing the infrared sensing device 6 used for achieving recharging guidance on the terminal seat 14, the need for an additional component to support and fix the infrared sensing device 6 is eliminated, thereby reducing manufacturing costs and making the structure of the intelligent lawn mower 100 more compact.

Referring to FIG. 3, the second shell 12 is located above the first shell 11. The first shell 11 and the second shell 12 are connected to each other to define a first cavity 15. The terminal seat 14 and the first shell 11 are connected to each other to define a second cavity 16. The first cavity 15 and the second cavity 16 are communicated with each other. Specifically, in this embodiment, the first cavity 15 is formed between the first shell 11 and the second shell 12, and the second cavity 16 is formed inside the terminal seat 14.

Specifically, a first sealing member 81 is installed at the connection between the first shell 11 and the second shell 12, and a second sealing member 82 is installed at the connection between the first shell 11 and the terminal seat 14. The infrared sensing device 6 is installed in the second cavity 16.

In this embodiment, by providing the first sealing member 81 and the second sealing member 82, the above-mentioned first cavity 15 and the above-mentioned second cavity 16 are in fluid communication with each other, but are isolated from the external environment. On one hand, the infrared sensing device 6 received in the second cavity 16 is isolated from the external environment, thereby providing good waterproof sealing effect and extending the lifespan of the infrared sensing device. On the other hand, compared to designing an additional fixing seat for installing the infrared sensing device 6, the waterproof sealing of the infrared sensing device 6 in this embodiment is achieved through the sealing between the terminal seat 14 and the first shell 11, eliminating the need for an additional sealing device, simplifying the structure and reducing costs.

Further, the charging terminals 7 include a first electrode 71 and a second electrode 72. The terminal seat 14 is formed with two slots 144 which are parallel to each other, with one slot 144 being inserted by the first electrode 71 and the other slot 144 being inserted by the second electrode 72. The first electrode 71 and the second electrode 72 are accommodated in the second cavity 16. The infrared sensing device 6 is installed between the first electrode 71 and the second electrode 72. Specifically, the terminal seat 14 is provided with an installation groove 145 between the first electrode 71 and the second electrode 72, and the infrared sensing device 6 is located within the installation groove 145.

In this embodiment, by installing the infrared sensing device 6 between the first electrode 71 and the second electrode 72, the space between the two electrodes is utilized efficiently, making the structure of the terminal seat 14 more compact, and further making the structure of the intelligent lawn mower 100 more compact.

The first shell 11 includes a first opening 111 communicating with the first cavity 15, and the terminal seat 14 includes a second opening 141 communicating with the second cavity 16. The first opening 111 and the second opening 141 are communicated with each other. Specifically, the above-mentioned charging terminals 7 are electrically connected to the control module 4 or the battery pack through second wires 92, and the second wires 92 extend from electrical connection parts of the charging terminals 7 in the second cavity 16 and pass through the first opening 111 and the second opening 141 into the first cavity 15 to connect with the control module 4.

Further, the control module 4 is electrically connected to the infrared sensing device 6 through first wires 91. The control module 4 is at least partially accommodated in the first cavity 15, while the infrared sensing device 6 is located within the second cavity 16. The above-mentioned first wires 91 extend from the second cavity 16 and pass through the first opening 111 and the second opening 141 into the first cavity 15 to achieve the electrical connection between the control module 4 and the infrared sensing device 6.

In this embodiment, the communication between the first cavity 15 and the second cavity 16 is achieved through the first opening 111 and the second opening 141 that are communicated with each other. The first wires 91 used for electrically connecting the infrared sensing device 6 to the control module 4 and the second wires 92 used for electrically connecting the charging terminals 7 to the control module 4 or the battery pack are both routed through the first opening 111 and second opening 141. Thus, on one hand, the wiring layout of the intelligent lawn mower is simplified, making it easier to design for waterproof sealing; on the other hand, compared to designing an additional fixing seat to install the infrared sensing device 6, the infrared sensing device 6 and the charging terminals 7 in this embodiment share the same wiring channel, thereby reducing costs and simplifying the structure of the intelligent lawn mower 100.

Further, the terminal seat 14 further includes a third opening 142 communicating with the second cavity 16 and a light-transmitting plate 143 for allowing external light to pass through. The light-transmitting plate 143 is installed at the third opening 142 and matches with the third opening 142 to seal the third opening 142. Specifically, the infrared sensing device 6 is installed within the aforementioned second cavity 16, the terminal seat 14 is provided with the third opening 142, the third opening 142 is formed on one side wall of the installation groove 145, and the third opening 142 is located in front of the infrared sensing device 6, allowing external light to enter the second cavity 16 through the third opening 142. Thus, the infrared sensing device 6 can receive external light through the third opening 142. Thus, the infrared sensing device 6 can receive external light through the third opening 142.

Optionally, in this embodiment, the light-transmitting plate 143 is further installed at the third opening 142. The light-transmitting plate 143 covers the third opening 142 and seals the third opening 142. The connection between the third opening 142 and the light-transmitting plate 143 can be achieved by adhesive bonding or injection molding, thereby enhancing the sealing of the terminal seat 14.

Further, the first opening 111 is opened downward along the height direction of the intelligent lawn mower 100, and the second opening 141 is opened upward along the height direction of the intelligent lawn mower 100. Specifically, the first opening 111 and the second opening 141 that are communicated with each other are oppositely opened along the height direction of the intelligent lawn mower 100. Therefore, during the process of extending the first wires 91 and the second wires 92 from the second cavity 16 through the first opening 111 and the second opening 141 into the first cavity 15, the first wires 91 and the second wires 92 do not need to be bent to adjust the routing direction, further simplifying the wiring layout of the intelligent lawn mower 100.

The housing 1 further includes a light-blocking cover 18 that is at least partially positioned in front of the terminal seat 14. The light-blocking cover 18 and at least one of the first shell 11 and the second shell 12 are connected to each other to define a third cavity 17, and the terminal seat 14 is accommodated in the third cavity 17. Specifically, the light-blocking cover 18 is partially positioned in front of the terminal seat 14 and partially positioned above the terminal seat 14 to cover the terminal seat 14, and the light-blocking cover 18 is connected to the first shell 11, with the third cavity 17 being formed between the light-blocking cover 18 and the first shell 11 for accommodating the terminal seat 14.

Thus, when the intelligent lawn mower 100 performs mowing operations in an outdoor environment, other ambient light such as sunlight is difficult to reach the infrared sensing device 6 hidden deep inside the housing 1 due to being blocked by the light-blocking cover 18. As a result, the infrared sensing device 6 will not be falsely triggered by the infrared beams in other ambient light such as sunlight, so that the intelligent lawn mower 100 can accurately perform the recharging action without being affected by ambient light.

Further, the infrared sensing device 6 of the intelligent lawn mower 100 is positioned inside the housing 1 to avoid direct exposure to external light. Specifically, the light-blocking cover 18 is provided with a light-transmitting opening 13, and the infrared sensing device 6 receives external light only through the light-transmitting opening 13, wherein the horizontal distance between the installation position of the infrared sensing device 6 and the light-transmitting opening 13 is not less than 30 mm.

Thus, when the intelligent lawn mower 100 performs mowing operations in an outdoor environment, other ambient light such as sunlight is difficult to reach the infrared sensing device 6 hidden deep inside the housing 1. As a result, the infrared sensing device 6 will not be falsely triggered by the infrared beams in other ambient light such as sunlight, so that the intelligent lawn mower 100 can accurately perform the recharging action without being affected by ambient light.

The infrared sensing device 6 includes a circuit board 61 and a photodiode 62 installed on the circuit board 61. External light passes through the aforementioned light-transmitting opening 13 to illuminate the photodiode 62. Specifically, the light-transmitting opening 13 includes a first opening wall 131 and a second opening wall 132 located below the first opening wall 131. In the height direction of the intelligent lawn mower 100, the installation position of the photodiode 62 is located between the first opening wall 131 and the second opening wall 132.

Thus, the infrared emitting device of the charging station 200 can be directly aligned with the infrared sensing device 6 of the intelligent lawn mower 100. During the recharging and docking process, the infrared light emitted by the infrared emitting device can quickly pass through the above-mentioned light-transmitting opening 13 to be received by the photodiode 62, thus facilitating the recharging and docking between the intelligent lawn mower 100 and the charging station 200, and improving the efficiency of the recharging and docking process.

Further, the light-transmitting opening 13 further includes a light entry point 133, and the light entry point 133 is located at the lowermost part and the frontmost part of the first opening wall 131. The angle between the connecting line L1 between the light entry point 133 and the center point of the photodiode 62 and the horizontal line L2 is not greater than 15 degrees.

In this embodiment, by comprehensively designing the size of the light-transmitting opening 13 and the horizontal distance between the photodiode 62 and the light-transmitting opening 13, the sunlight is blocked by the above-mentioned first opening wall 131 during most of the time and cannot pass through the light-transmitting opening 13 to illuminate the photodiode 62, thereby further reducing the impact of ambient light such as sunlight on the recharging and docking between the intelligent lawn mower 100 and the charging station 200, and improving the efficiency of the recharging and docking process.

The present invention is not limited to the specific embodiments described above. Those of ordinary skill in the art can easily understand that there are many alternative solutions for the intelligent lawn mower of the present invention without departing from the principles and scope of the present invention. The scope of protection of the present invention is defined by the content of the claims.

1. An intelligent lawn mower, comprising:
a housing;
an energy module provided in the housing for supplying power to the intelligent lawn mower;
a plurality of charging terminals provided in the housing and electrically connected to the energy module, the charging terminals being configured to connect to an external charging station for recharging the energy module; and
an infrared sensing device configured to guide the intelligent lawn mower back to the charging station;
wherein the intelligent lawn mower further comprises a terminal seat provided with the charging terminals, and the infrared sensing device is installed on the terminal seat.

2. The intelligent lawn mower as claimed in claim 1, wherein the housing comprises a first shell and a second shell, the first shell and the second shell are connected to each other to define a first cavity, the terminal seat and the first shell are connected to each other to define a second cavity, the first cavity and the second cavity are communicated with each other.

3. The intelligent lawn mower as claimed in claim 2, wherein the first shell comprises a first opening communicating with the first cavity, the terminal seat comprises a second opening communicating with the second cavity, the second opening and the first opening are communicated with each other.

4. The intelligent lawn mower as claimed in claim 3, wherein the intelligent lawn mower further comprises first wires and a control module electrically connected to the infrared sensing device through the first wires, the control module is at least partially accommodated in the first cavity, the first wires extend from the second cavity and pass through the first opening and the second opening into the first cavity.

5. The intelligent lawn mower as claimed in claim 4, wherein the intelligent lawn mower further comprises second wires extending from the second cavity and passing through the first opening and the second opening into the first cavity, and the charging terminals are electrically connected to the control module through the second wires.

6. The intelligent lawn mower as claimed in claim 3, wherein the first opening is opened downward along a height direction of the intelligent lawn mower.

7. The intelligent lawn mower as claimed in claim 3, wherein the second opening is opened upward along a height direction of the intelligent lawn mower.

8. The intelligent lawn mower as claimed in claim 3, wherein the terminal seat further comprises a third opening communicating with the second cavity, and the third opening is located in front of the infrared sensing device for allowing the infrared sensing device to receive external light through the third opening.

9. The intelligent lawn mower as claimed in claim 8, wherein the terminal seat further comprises a light-transmitting plate allowing external light to pass through, and the light-transmitting plate covers the third opening.

10. The intelligent lawn mower as claimed in claim 2, wherein a direction in which the intelligent lawn mower enters the charging station is defined as a front direction, the housing further comprises a light-blocking cover at least partially positioned in front of the terminal seat, and the light-blocking cover is partially positioned above the terminal seat to block ambient light.

11. The intelligent lawn mower as claimed in claim 10, wherein the light-blocking cover and at least one of the first shell and the second shell are connected to each other to define a third cavity, and the terminal seat is accommodated in the third cavity.

12. The intelligent lawn mower as claimed in claim 10, wherein the light-blocking cover comprises a light-transmitting opening, the infrared sensing device receives external light through the light-transmitting opening, and a horizontal distance between an installation position of the infrared sensing device and the light-transmitting opening is not less than 30 mm.

13. The intelligent lawn mower as claimed in claim 12, wherein the infrared sensing device comprises a circuit board and a photodiode installed on the circuit board, with the photodiode facing the light-transmitting opening, and the photodiode receives external light through the light-transmitting opening.

14. The intelligent lawn mower as claimed in claim 13, wherein the light-transmitting opening comprises a first opening wall and a second opening wall located below the first opening wall, in a height direction of the intelligent lawn mower, an installation position of the photodiode is located between the first opening wall and the second opening wall.

15. The intelligent lawn mower as claimed in claim 14, wherein the light-transmitting opening further comprises a light entry point formed at a lowermost part of the first opening wall and located at a frontmost part of the first opening wall, an angle between a connecting line between the light entry point and a center point of the photodiode and a horizontal line is not greater than 15 degrees.

16. The intelligent lawn mower as claimed in claim 2, wherein a first sealing member is installed at the connection between the first shell and the second shell, and a second sealing member is installed at the connection between the first shell and the terminal seat.

17. The intelligent lawn mower as claimed in claim 11, wherein the charging terminals comprises a first electrode and a second electrode arranged in parallel to the first electrode; and the infrared sensing device is provided between the first electrode and the second electrode.

18. The intelligent lawn mower as claimed in claim 2, wherein the infrared sensing device is provided in the second cavity.

19. An automatic working system, comprising an intelligent lawn mower and an external charging station for recharging the intelligent lawn mower, the intelligent lawn mower comprising:
a housing;
an energy module provided in the housing for supplying power to the intelligent lawn mower;
a plurality of charging terminals provided in the housing and electrically connected to the energy module, the charging terminals being configured to connect to the external charging station for recharging the energy module; and
an infrared sensing device configured to guide the intelligent lawn mower back to the charging station;
wherein the intelligent lawn mower further comprises a terminal seat provided with the charging terminals, and the infrared sensing device is installed on the terminal seat.

20. An automatic working system, comprising:
an intelligent lawn mower, autonomously moving and mowing within a working area, comprising a housing, a plurality of charging terminals, a terminal seat provided with the charging terminals, and an infrared sensing device provided in the housing;
an external charging station, configured to be connected to the charging terminals for recharging the intelligent lawn mower, wherein the charging station comprises an infrared emitting device, and the infrared emitting device cooperates with the infrared sensing device to guide the intelligent lawn mower back to the charging station;
wherein the infrared sensing device is installed on the terminal seat, the housing is provided with a light-transmitting opening, the infrared sensing device receives external light through the light-transmitting opening, and a horizontal distance between an installation position of the infrared sensing device and the light-transmitting opening is not less than 30 mm.
